(19) United States
(12) Patent Application Publication
(10) Pub. No.: US 2023/0341938 A1
(43) Pub. Date: Oct. 26, 2023

(54) OPERATING DEVICE

(71) Applicant: KABUSHIKI KAISHA TOKAI RIKA DENKI SEISAKUSHO, Aichi (JP)

(72) Inventor: Yasuhiro ONO, Aichi (JP)

(73) Assignee: KABUSHIKI KAISHA TOKAI RIKA DENKI SEISAKUSHO, Aichi (JP)

(21) Appl. No.: 17/759,716

(22) PCT Filed: Jan. 25, 2021
(86) PCT No.: PCT/JP2021/002481

§ 371 Date: Jul. 28, 2022

(30) Foreign Application Priority Data
Feb. 4, 2020 (JP) 2020-016985

(51) Int. Cl. G06F 3/01; G06F 3/044; B60K 35/00

(52) U.S. Cl. CPC G06F 3/016; G06F 3/0446; B60K 35/00; B60K 2370/1434; B60K 2370/1468; B60K 2370/158

(57) ABSTRACT

An operation device includes a touch detector and a display unit. The touch detector detects a touch operation performed on an operation surface and outputs a touch detection signal corresponding to the touch operation. The display unit displays an image of a display item for the touch operation in the operation surface. The operation device also includes a covering that covers at least part of the touch detector and the display unit. The covering transmits the image of the display item displayed on the display unit to allow the display item to be viewed on the operation surface. The operation device further includes an organic piezoelectric element that is light-transmissive and allows the image of the display item displayed on the display unit to be transmitted. The organic piezoelectric element is vibrated when the touch operation is performed so that the touch operation can be perceived.

### TECHNICAL FIELD

The present invention relates to a touch-sensitive operation device.

### BACKGROUND ART

A touchpad device (refer to, for example, Patent Document 1) that remotely operates the screen of a display and uses a touchpad separated from the display is one type of a known touch-sensitive operation device including an operation surface that is touched (swiped and the like) for operation.

### CITATION LIST

### Patent Literature

Patent Document 1: Japanese Laid-Open Patent Publication No. 2013-206341

### SUMMARY OF INVENTION

### Technical Problem

A touchpad is installed near the driver seat at a specified position such as on the center console or the steering wheel and is always located near the driver seat. In order to improve the design of the room around the driver seat, a movable touchpad may be accommodated in a predetermined frame when the touchpad is not in use and rotated or moved out of the frame when used. However, this results in the touchpad having a complicated structure and being inconvenient.

It is an objective of the present invention to provide an operation device that improves aesthetic appeal and convenience with a simple structure.

### Solution to Problem

An operation device according to one embodiment includes: a touch detector that detects a touch operation performed on an operation surface and outputs a touch detection signal corresponding to the touch operation; a display unit that displays an image of a display item for the touch operation in the operation surface; a covering that covers at least part of the touch detector and the display unit, transmits the image of the display item displayed on the display unit, and allows the display item to be viewed on the operation surface; and an organic piezoelectric element that is light-transmissive and allows the image of the display item displayed on the display unit to be transmitted. The organic piezoelectric element is vibrated when the touch operation is performed so that the touch operation can be perceived.

### BRIEF DESCRIPTION OF DRAWINGS

FIG. 1 is a perspective view illustrating an operation device according to one embodiment installed in a passenger compartment.

FIG. 2 is a diagram illustrating the configuration of the operation device.

FIG. 3 is a cross-sectional view showing the structure of an organic piezoelectric element.

FIG. 4 is a flowchart showing a process executed during a touch operation.

FIG. 5A is a perspective view of an operation unit that shows display items through a transmissive leather.

FIG. 5B is a perspective view of an operation unit that shows display items through a transmissive leather.

FIG. 6 is a cross-sectional view of a modified example of the operation device.

FIG. 7 is a cross-sectional view of a modified example of the operation device.

FIG. 8 is a cross-sectional view of a modified example of the operation device.

FIG. 9 is a cross-sectional view of a modified example of the operation device.

### DESCRIPTION OF EMBODIMENTS

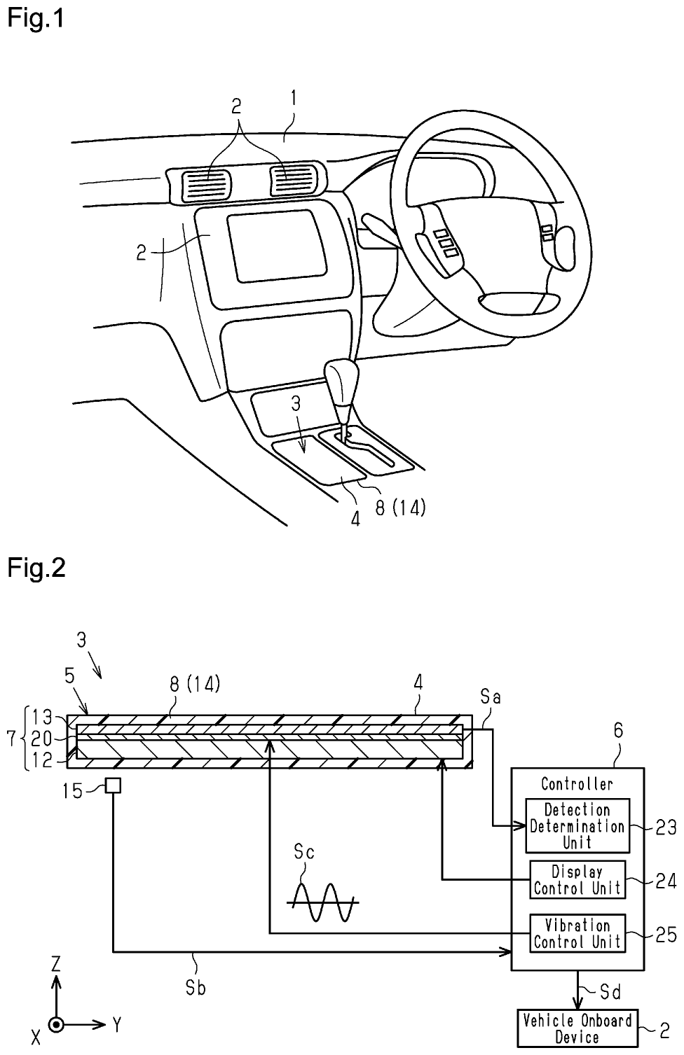

An operation device according to one embodiment will now be described with reference to FIGS. 1 to 5.

As shown in FIG. 1, an operation device 3 operated to actuate vehicle onboard devices 2 is arranged in a passenger compartment of a vehicle 1. The operation device 3 of the present example is of a touch panel type that is operated when a user touches an operation surface 4, which is arranged on the outer surface of the device, with a finger or the like. The operation device 3 is arranged, for example, on the center console or the like in the passenger compartment. Examples of the vehicle onboard devices 2 operated with the operation device 3 include an air conditioner, an audio device, a car navigation device, and the like.

As shown in FIG. 2, the operation device 3 includes an operation unit 5 that serves as an interface for touch operations and a controller 6 that controls the actuation of the operation unit 5. The operation unit 5 includes a unit body 7 and a covering 8. The unit body 7 displays various types of images on the operation surface 4 and detects touch operations performed on the operation surface 4. The covering 8 covers the unit body 7.

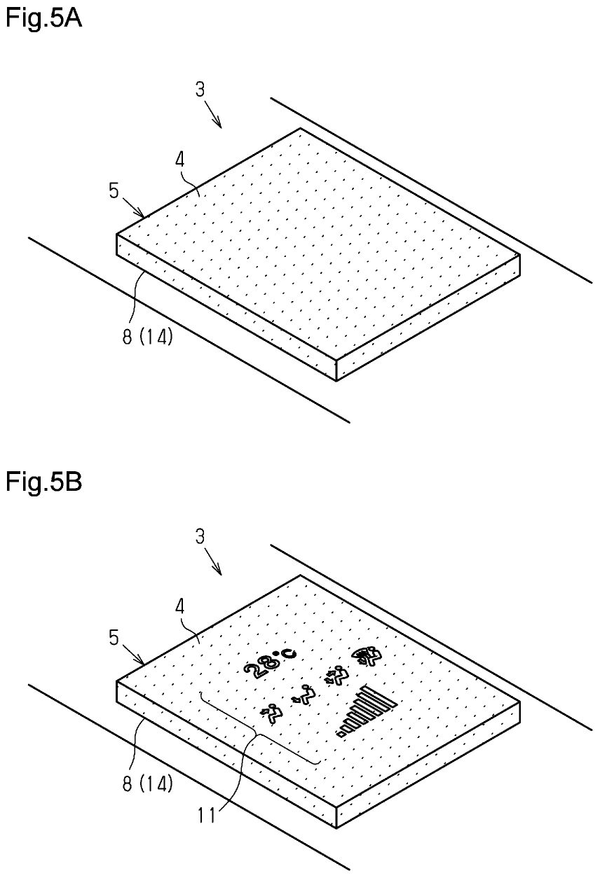

The unit body 7 includes a display unit 12 that displays images of display items 11 (refer to FIG. 5B) on the operation surface 4. Each display item 11 is operated to select or execute the functionality of the corresponding vehicle onboard device 2. The unit body 7 further includes an organic piezoelectric element 20 that vibrates when a user performs a touch operation to provide the user with a feedback of the operation and a touch detector 13 that detects a touch operation performed on the operation surface 4. The display unit 12 may be a flexible organic EL display. The display unit 12 displays images of the display items 11 on the operation surface 4, which undergoes touch operations, that is, on the upper surface of the covering 8. When the operated subject is the air conditioner, the display items 11 will include a flow rate adjustment switch, a blow mode selection switch, a temperature adjustment switch, an on/off switch, an A/C switch, an intake/recirculation selection switch, and the like.

The touch detector 13 may be, for example, an electrostatic electrode and allows for the transmission of images that are displayed on the display unit 12 at the back side of the touch detector 13. The touch detector 13 outputs a touch detection signal Sa corresponding to a touch operation performed on the operation surface 4.

The covering 8 is made of a transmissive leather 14 that transmits light. Thus, the images of the display items 11 displayed on the display unit 12 are transmitted through the covering 8 to allow a user to view the display items 11 on the operation surface 4. The transmissive leather 14 of the present example has, for example, a transmittance value in the visible light range of 0.1 to 20%. The transmissive leather 14 entirely covers the group of the display unit 12, the touch detector 13, and the organic piezoelectric element 20. The transmissive leather 14 may have an embossed surface and be formed from a plastic such as polyvinylchloride or olefin-based thermoplastic elastomer (with thickness of about 0.5 mm). The transmissive leather 14 wraps the group of the display unit 12, the touch detector 13, and the organic piezoelectric element 20.

The organic piezoelectric element 20 is arranged between the display unit 12 and the touch detector 13. The organic piezoelectric element 20, which is a type of piezoelectric element, uses organic polymer materials. The organic piezoelectric element 20 has the form a thin plate. The organic piezoelectric element 20 is transparent and allows light to be transmitted so that the images displayed on the display unit 12 at the back side are transmitted to the touch detector 13. The piezoelectric element also converts an electric signal into vibration. The organic piezoelectric element 20 is flexible. The characteristics of the organic piezoelectric element 20 are such that, for example, the resonance frequency is low, flexibility is provided to allow for deformation, and the piezoelectric constant is low.

The operation unit 5 includes an operation intention detector 15 used to determine whether the user intends to operate the operation unit 5. The operation intention detector 15 is a pressure sensor embedded in, for example, the operation unit 5 and detects when a hand, a finger, or the like of the user is placed on the upper surface (such as operation surface 4) of the operation unit 5. When detecting the placement of the hand, the finger, or the like of the user, the operation intention detector 15 outputs an operation intention detection signal Sb to the controller 6. The operation intention detector 15 may be any type of sensor and arranged at any position as long as the operation intention detector 15 allows for determination that the user intends to operate the operation surface 4.

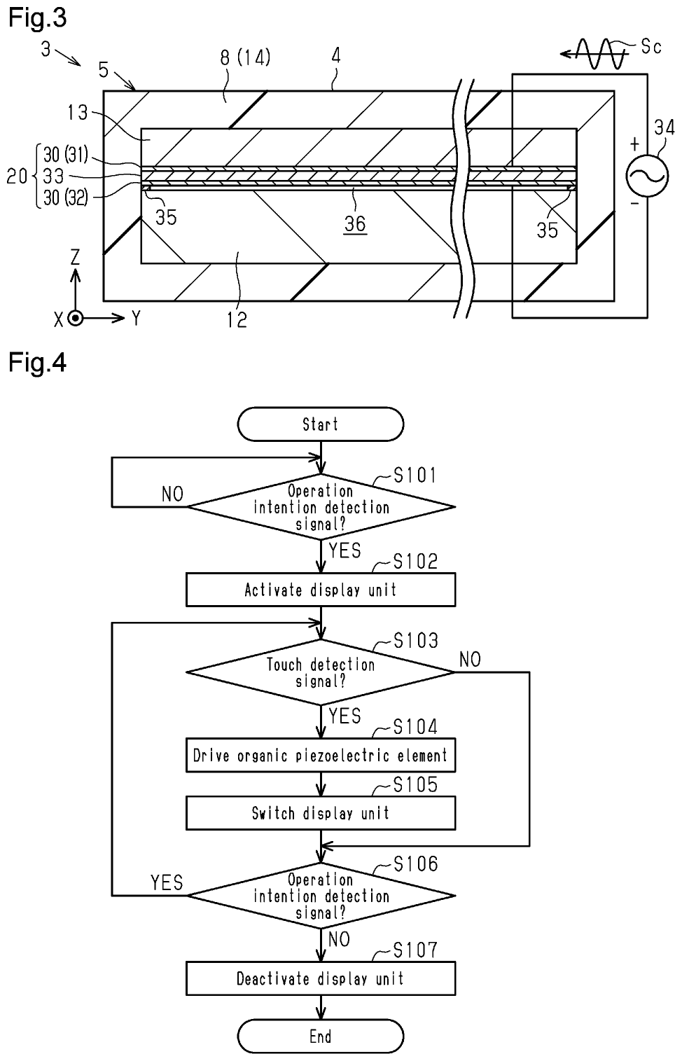

As shown in FIG. 3, the organic piezoelectric element 20 includes a pair of positive and negative electrodes 30 (upper electrode 31, lower electrode 32) and an organic piezoelectric body 33 arranged between the upper electrode 31 and the lower electrode 32. The upper electrode 31 and the lower electrode 32 are both flat and have the same area. When the upper electrode 31 is the positive electrode and the lower electrode 32 is the negative electrode, the upper electrode 31 is connected to the positive (+) side of an electrode power supply 34 and the lower electrode 32 is connected to the negative (−) side of the electrode power supply 34. The electrodes 30 may be formed by, for example, a polythiophene-based conductive polymer.

The organic piezoelectric body 33 may be formed from a polymer-based permanent dipole type piezoelectric material, for example, polyvinylidene difluoride (PVDF). In addition to vinylidene fluoride, the piezoelectric material may be trifluoroethylene (TrFE). Other piezoelectric materials that can be used for the organic piezoelectric body 33 than the above materials include, for example, a composite type or electret type of piezoelectric ceramic particles. Examples of the electret type include porous PP (polypropylene) and stretched PTFE (polytetrafluoroethylene).

The organic piezoelectric element 20 includes columns 35 that support the group of the organic piezoelectric body 33 and the positive and negative electrodes 30 from the back side. The columns 35 of the present example are arranged at the two ends of the operation unit 5 (unit body 7) in the width direction (Y-axis direction in FIG. 3). The group of the organic piezoelectric body 33 and the positive and negative electrodes 30 is supported by the columns 35 and spaced apart by a predetermined gap 36 from the display unit 12.

As shown in FIG. 2, the controller 6 includes a detection determination unit 23 that determines whether a touch operation has been performed on the operation surface 4 based on a touch detection signal Sa input from the touch detector 13, a display control unit 24 that controls the display state of the display unit 12, and a vibration control unit 25 that controls the actuation of the organic piezoelectric element 20. Among the display items 11 displayed by the display control unit 24, the controller 6 recognizes the one of the display items 11 that has been touched based on a determination result of the detection determination unit 23 and controls the corresponding vehicle onboard devices 2 for actuation in accordance with the touch-operated display item 11.

The vibration control unit 25 outputs a sine-wave voltage signal Sc to the organic piezoelectric element 20 when a touch operation is performed to finely vibrate the organic piezoelectric element 20. The voltage of the voltage signal Sc is applied between the upper electrode 31 and the lower electrode 32. In this manner, when a touch operation is performed, the organic piezoelectric element 20 is expanded and contracted to finely vibrate based on the voltage applied in accordance with the sine-wave voltage signal Sc so that the user can perceive a feedback of the touch operation.

The operation of the operation device 3 in the present embodiment will now be described with reference to FIGS. 4 and 5. The flowchart of FIG. 4 starts when, for example, the power supply of the vehicle 1 is in an ACC-on state (accessory power supply is switched on) or in an IG-on state (ignition power supply is switched on) and the operation device 3 is activated.

As shown in FIG. 4, in step S101, the controller 6 determines whether an operation intention detection signal Sb has been received from the operation intention detector 15. Specifically, when the operation intention detector 15 detects the placement of a hand, a finger, or the like of the user on the operation surface 4 indicating that the user intends to operate the operation device 3, the controller 6 receives the operation intention detection signal Sb from the operation intention detector 15. When the operation intention detection signal Sb is received, the controller 6 proceeds to step S102. When the operation intention detection signal Sb is not received, the controller 6 repeats step S101.

When the controller 6 receives the operation intention detection signal Sb from the operation intention detector 15, the controller 6 activates the display unit 12 in step S102. The display of the display unit 12 is controlled by the display control unit 24.

FIGS. 5A and 5B illustrate the display unit 12 in a deactivated state and an activated state, respectively. As shown in FIG. 5A, when the display unit 12 is deactivated, nothing is displayed in the covering 8. In this case, the upper surface of the operation surface 4 has a leather-like appearance. Thus, the operation surface 4 has a high aesthetic appeal when the display unit 12 is deactivated.

As shown in FIG. 5B, when the display unit 12 is activated, images of the display items 11 displayed on the display unit 12 are projected onto the covering 8. In the present example, the organic piezoelectric element 20 is transparent, and the touch detector 13 is an electrostatic electrode. Thus, images displayed on the display unit 12 are transmitted through the organic piezoelectric element 20 and the touch detector 13 to the covering 8. This allows the images of the display items 11 to be viewed through the covering 8. The user operates the desired vehicle onboard device 2 by touching one of the display items 11 projected onto the covering 8. In the present example, the covering 8 is a type of plastic such that the touch operation performed on the upper surface of the covering 8 is transferred to the touch detector 13 through the covering 8.

As shown in FIG. 4, in step S103, the controller 6 determines whether a touch detection signal Sa has been received from the touch detector 13. In the present example, the detection determination unit 23 determines the coordinates of where the touch operation is performed on the operation surface 4 based on the received touch detection signal Sa and recognizes the one of the display items 11 viewed through the covering 8 of which image has been touched. The controller 6 outputs a control signal Sd to the vehicle onboard device 2 corresponding to the touched display item 11 and actuates the onboard devices 2 based on the control signal Sd. When the controller 6 receives the touch detection signal Sa in step 103, the controller 6 proceeds to step S104. When the controller 6 does not receive the touch detection signal Sa in step 103, the controller 6 proceeds to step S106.

When a touch operation performed on the operation surface 4 is detected, the vibration control unit 25 drives the organic piezoelectric element 20 in step S104. In other words, the vibration control unit 25 outputs a sine-wave voltage signal Sc to the organic piezoelectric element 20 so that the organic piezoelectric element 20 vibrates finely. In the present example, the organic piezoelectric element 20 is repeatedly deformed in the vertical direction to generate vibration. The vibration of the organic piezoelectric element 20 integrally vibrates the touch detector 13 and the covering 8. The vibration is transferred as a feedback of the touch operation to a finger or the like of the user that performed the touch operation. The organic piezoelectric element 20 vibrates for a fixed period from when the touch operation is detected.

In step S105, the display control unit 24 switches the display unit 12 to a display state that is in accordance with the touch operation performed by the user. For example, when a touch operation is performed to change the temperature set for the air conditioner, the changed setting is displayed on the display unit 12.

In step S106, the controller 6 determines whether an operation intention detection signal Sb has been received from the operation intention detector 15. In other words, the controller 6 determines whether the user intends to continuously operate the operation unit 5. When the controller 6 receives the operation intention detection signal Sb, the controller 6 returns to step S103 and repeats the process. When the controller 6 does not receive the operation intention detection signal Sb, the controller 6 proceeds to step S107.

When the controller 6 does not receive the operation intention detection signal Sb from the operation intention detector 15, the controller 6 deactivates the display unit 12 in step S107. Thus, the images of the display items 11 will no longer be visible on the operation surface 4 of the operation unit 5, that is, the upper surface of the covering 8 so that the covering 8 will return to the leather-like appearance.

The operation device 3 in the above embodiment has the following advantages.

(1) The operation device 3 includes the touch detector 13, the display unit 12, the covering 8, and the organic piezoelectric element 20. The touch detector 13 detects a touch operation performed on the operation surface 4 and outputs a touch detection signal Sa corresponding to the touch operation. The display unit 12 displays images of the display items 11 for touch operations in the operation surface 4. The covering 8 covers at least part of the display unit 12 and the touch detector 13, transmits the images of the display items 11 displayed on the display unit 12, and allows the display items 11 to be viewed on the operation surface 4. The organic piezoelectric element 20 is light-transmissive and transmits the images of the display items 11 displayed on the display unit 12. When a touch operation is performed, the organic piezoelectric element 20 vibrates to provide the user with a feedback that can be perceived.

With the structure of the present example, when the display unit 12 is deactivated, the pattern on the upper surface of the covering 8 serves as an ornamental surface and improves the aesthetic appeal of the operation device 3. Thus, the aesthetic appeal of the operation device 3 is obtained when deactivating the display unit 12. Further, the organic piezoelectric element 20 is light-transmissive. Thus, when the display unit 12 is activated, images of the display items 11 displayed on the display unit 12 are transmitted through the organic piezoelectric element 20 to the operation surface 4 so that a touch operation can be performed. When one of the display items 11 is touched, the organic piezoelectric element 20 vibrates to provide the user with a feedback that can be perceived. Thus, the aesthetic appeal is improved and a feedback to a touch operation can be provided with a simple structure.

In short, the aesthetic appeal of the operation device 3 is improved (even when operation device 3 is installed at fixed position) by switching the display unit 12 between an activated state and a deactivated state. Further, when a touch operation is performed, the operation surface 4 is vibrated to provide the user with a feedback that can be perceived so that the user can acknowledge completion of the touch operation. Thus, the aesthetic appeal and convenience are improved with a simple structure.

(2) The operation device 3 includes the vibration control unit 25 that controls the organic piezoelectric element 20 in accordance with a touch detection signal Sa of the touch detector 13. The vibration control unit 25 executes control so that the organic piezoelectric element 20 vibrates in various modes in accordance with touch operations. This generates vibrations in accordance with the type of the touched display item 11 and how the touch operation is performed.

(3) The operation device 3 includes the positive and negative electrodes 30 (upper electrode 31, lower electrode 32) and the organic piezoelectric body 33 arranged between the electrodes 30. The organic piezoelectric body 33 vibrates when voltage (voltage signal Sc) is applied between the electrodes 30. In this case, the voltage (voltage signal Sc) applied between the electrodes 30 is controlled to vibrate the organic piezoelectric element 20 in a predetermined mode.

(4) The organic piezoelectric element 20 includes the columns 35 that support the group of the organic piezoelectric body 33 and the electrodes 30 from the back side of the organic piezoelectric element 20 where the surface opposed to the display unit 12 is located. In this case, the columns 35 raise the group of the organic piezoelectric body 33 and the electrodes 30 so that the voltage (voltage signal Sc) applied between the electrodes 30 can vertically bend and vibrate the group of the organic piezoelectric body 33 and the electrodes 30.

(5) The organic piezoelectric element 20 is arranged between the display unit 12 and the touch detector 13. In this case, the organic piezoelectric element 20 is arranged on the lower surface of the touch detector 13, and vibration of the organic piezoelectric element 20 is directly transferred through the touch detector 13 to the operation surface 4. Thus, when a touch operation is performed, vibration of the organic piezoelectric element 20 is effectively transferred to the finger or the like that performed the touch operation.

The present embodiment may be modified as follows. The present embodiment and the following modifications can be combined as long as the combined modifications remain technically consistent with each other.

Operation Device 3

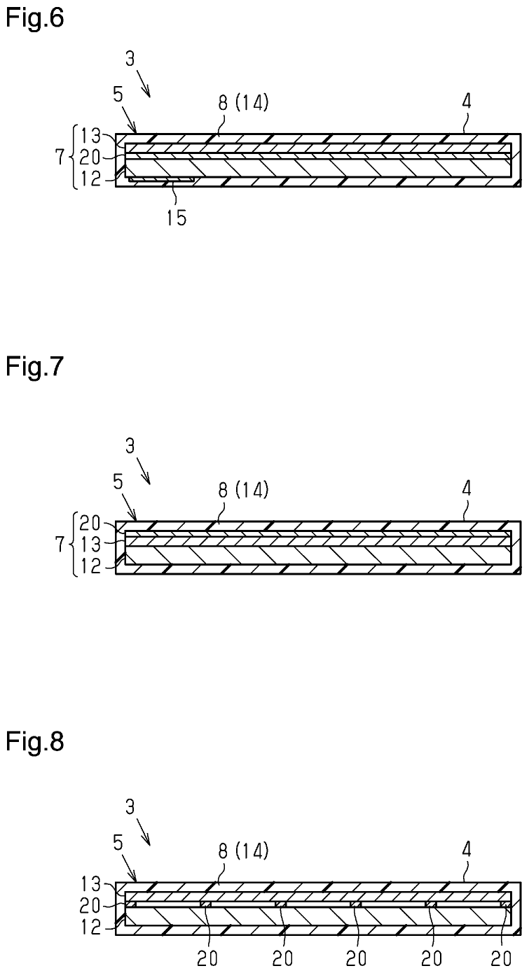

As shown in FIG. 6, the operation device 3 does not need to be fixed at an installation position. The operation device 3 may be of a handheld type, which is, for example, portable. In this case, the operation intention detector 15 may be a grip detector attached to the operation unit 5. Thus, when the grip detector detects that the operation device 3 is held by the user, the display unit 12 is activated. With this structure, the operation device 3 can be used as a portable terminal.

As shown in FIG. 7, the organic piezoelectric element 20 does not need to be arranged between the display unit 12 and the touch detector 13. The organic piezoelectric element 20 may be arranged, for example, on the surface (upper surface) of the touch detector 13.

As shown in FIG. 8, the organic piezoelectric element 20 does not need to be a single member. Plural organic piezoelectric elements 20 may be arranged. In this case, the organic piezoelectric element 20 may be arranged in a grid in a planar direction of the operation surface 4 of the operation unit 5.

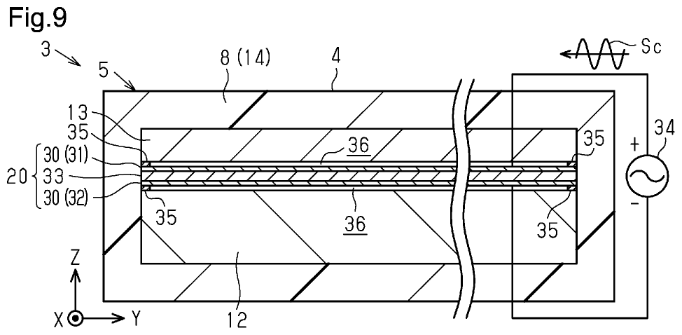

As shown in FIG. 9, the gap 36 is not limited to the back side of the organic piezoelectric element 20 and may be formed at both front and back sides of the organic piezoelectric element 20. Specifically, the gaps 36 may be formed between the display unit 12 and the organic piezoelectric element 20 and between the touch detector 13 and the organic piezoelectric element 20. The columns 35 may also be arranged at the edges of the upper surface of the organic piezoelectric element 20, and the touch detector 13 may be placed on the columns 35. When the organic piezoelectric element 20 has the gaps 36 at the front and back sides, the organic piezoelectric element 20 has a greater vibration effect. This will provide a preferable feedback to an operator that performs a touch operation.

Touch Detector 13

The touch detector 13 does not need to be of a capacitive type. The touch detector 13 may be modified to be of various types, such as a resistive film type.

The touch detector 13 does not need to be flat. The touch detector 13 may be curved.

The touch detector 13 may have a size (area) differing from the display unit 12.

Instead of activating the touch detector 13 when the operation intention detector 15 detects that the user intends to perform an operation, the touch detector 13 may be driven constantly subsequent to activation of the operation device 3.

Display Unit 12

The display unit 12 does not need to be an organic display. The display unit 12 may be modified to be a liquid crystal display or the like.

The display unit 12 may be inflexible.

The display unit 12 does not need to be flat. The display unit 12 may be curved.

Instead of activating the display unit 12 when the operation intention detector 15 detects that the user intends to perform an operation, the display unit 12 may be driven constantly subsequent to activation of the operation device 3.

Display Items 11

The display items 11 may be shown by any image selectable by a user such as an icon or a screen.

The display items 11 do not need to be shown by graphics and may be shown in text.

Covering 8

The covering 8 does not need to be the transmissive leather 14. The covering 8 may be any member as long as images of the display items 11 projected onto the lower surface of the covering 8 can be viewed.

The covering 8 does not need to entirely cover the group of the display unit 12, the touch detector 13, and the organic piezoelectric element 20. The covering 8 only needs to cover at least the upper surface of the group that is visible to the driver.

The covering 8 does not need to be a single covering. The covering 8 may be formed by plural coverings coupled together.

Organic Piezoelectric Element 20

The organic piezoelectric element 20 may include a substrate for the electrodes 30.

The organic piezoelectric element 20 does not need to include the columns 35.

The electrodes 30 only need to be light-transmissive and apply voltage to the organic piezoelectric body 33.

The organic piezoelectric body 33 may be made of a material that is transparent and generates vibration.

The organic piezoelectric element 20 may be arranged on the upper surface of the covering 8 (transmissive leather 14).

Others

During a touch operation, a single vibration pattern does not need to be used in response to a single touch operation. A feedback of the touch operation may be provided using plural vibration patterns.

The operation device 3 may be arranged on the steering wheel of the vehicle 1. In this case, the operation device 3 may be arranged on the grip portion (grip) of the steering wheel. Preferably, when the operation device 3 is arranged on the grip portion of the steering wheel, the operation device 3 is shaped to have a circular cross section.

The operation device 3 does not need to be applied to the vehicle 1. The operation device 3 may be applied to an apparatus or a device other than the vehicle 1.

### REFERENCE SIGNS LIST

3 . . . operation device, 4 . . . operation surface, 8 . . . covering, 11 . . . display items, 12 . . . display unit, 13 . . . touch detector, 20 . . . organic piezoelectric element, 25 . . . vibration control unit, 30 . . . electrodes, 31 . . . upper electrode, 32 . . . lower electrode, 33 . . . organic piezoelectric body, 35 . . . columns, Sa . . . touch detection signal, Sc . . . voltage signal

1. An operation device, comprising:
a touch detector that detects a touch operation performed on an operation surface and outputs a touch detection signal corresponding to the touch operation;
a display unit that displays an image of a display item for the touch operation in the operation surface;
a covering, wherein the covering covers at least part of the touch detector and the display unit and transmits the image of the display item displayed on the display unit to allow the display item to be viewed on the operation surface; and
an organic piezoelectric element that is light-transmissive and allows the image of the display item displayed on the display unit to be transmitted, wherein the organic piezoelectric element is vibrated when the touch operation is performed so that the touch operation can be perceived.

2. The operation device according to claim 1, further comprising:
a vibration control unit that controls the organic piezoelectric element in accordance with the touch detection signal of the touch detector.

3. The operation device according to claim 1, wherein
the organic piezoelectric element includes
two electrodes including a positive electrode and a negative electrode; and
an organic piezoelectric body arranged between the two electrodes and vibrated when voltage is applied between the two electrodes.

4. The operation device according to claim 3, wherein the organic piezoelectric element includes columns that support a group of the organic piezoelectric body and the two electrodes from a back side of the organic piezoelectric element where a surface opposed to the display unit is located.

5. The operation device according to claim 1, wherein the organic piezoelectric element is arranged between the display unit and the touch detector.

6. The operation device according to claim 1, wherein a gap is formed between the display unit and the organic piezoelectric element and between the touch detector and the organic piezoelectric element.
